(19) United States
(12) Patent Application Publication
(10) Pub. No.: US 2008/0035670 A1
(43) Pub. Date: Feb. 14, 2008

(54) VOLATILE SUBSTANCE RELEASING DEVICE AND METHOD FOR FILLING SAID DEVICE WITH SAID VOLATILE SUBSTANCE

(76) Inventors: Ulf Arno Timmann, Koln (DE); Jaume Josa, Erkrath (DE); Artur Menarski, Dusseldorf (DE); Michael Paton, Hertfordshire (GB)

Correspondence Address: John F. McNulty;Paul & Paul, 2900 Two Thousand Market Street, Philadelphia, PA, 19103, US

(21) Appl. No.: 11/843,058

(22) Filed: Aug. 22, 2007

Related U.S. Application Data
(63) Continuation of application No. PCT/EP2005/013759, filed on Dec. 21, 2005.

(30) Foreign Application Priority Data
Feb. 24, 2005 (DE) 10 2005 008 919.4

(51) Int. Cl. B67D 5/00; B65B 3/04; B67D 5/42

(52) U.S. Cl. 222/3; 141/3; 222/386

(57) ABSTRACT

A device is provided for releasing a volatile substance and a method of filling certain embodiments of the device with the volatile substance. A container is provided, with an internal space that is limited by means of a movable plunger that moves along a path during the change in volume of the medium, such that the change in volume of a carrier essentially correspondence to the change in volume of the internal space, due to the movement of the plunger along the path. The volatile substance can preferably be a fragrance.

### CROSS-REFERENCE TO RELATED APPLICATIONS

This is a continuation of PCT/EP2005/013759, filed Dec. 21, 2005, the complete disclosure of which is herein incorporated by reference.

The present invention relates to a device for releasing a volatile substance. The invention further relates to a method for filling certain embodiments of the device with said volatile substance.

### BACKGROUND OF THE INVENTION

EP 1 406 676 discloses a device for releasing a volatile substance. The device is an air freshener device, in which the volatile substance is a fragrance with which a room or the like can be freshened. A container of the air freshener possesses a cavity for receiving a medium in the form of a gel matrix that serves as a carrier for the fragrance. The gel matrix shrinks when the fragrance evaporates. The container consists of two segments that are free moving with respect to each other. The gel matrix is located between both of the segments and abuts each end wall. As the gel matrix shrinks, the segments move together longitudinally in a telescoping manner. The movement of one segment relative to the other provides a visual cue as to the shrinkage of the gel matrix and thereby the condition of the air freshener device.

EP 0 814 657 shows an air freshener with a container in which is located a mat impregnated with a deodorant. As the deodorant or fragrance evaporates, the mat shrinks, wherein a mechanical indicator is provided with at least one element that remains in contact with an edge of the mat. As the mat shrinks, the edge moves correspondingly and therewith also the attached element. Thus, the element covers a range such that a consumption of the volatile substance can be displayed. Because on shrinking, the element always remains on the edge, it thereby presses with a certain spring force against the edge.

For the air fresheners shown in EP 1 406 676 and EP 0 814 657, the shrinkage of a carrier in one direction is recorded by means of a display device. However, the disclosed display device does not display the actual change in volume, but only the unidirectional shrinkage of the carrier. This can lead to unacceptable display results as the shrinkage of the carrier in the other directions is not even displayed and consequently reliable information on the change in volume of the carrier is not possible. Accordingly, the invention is based on the object of providing a device for releasing a volatile substance in which, in so far as a display device is provided, the consumption of the volatile substance can be correctly and relatively accurately displayed.

### SUMMARY OF INVENTION

The object on which the invention is based is achieved in that the internal space of the container is limited by means of a movable plunger that moves along a path during the change in volume of the medium, wherein the change in volume of the carrier essentially corresponds to a change in volume of the internal space due to the movement of the plunger along the path.

### FURTHER DESCRIPTION OF THE INVENTION

As the medium diminishes in volume or shrinks, the plunger is displaced, whereby the internal space of the container becomes smaller. The change in volume or the reduction in volume of the container caused by the plunger thus corresponds to the reduction in volume of the medium. If, for example the medium completely fills the container, then the movable plunger ensures that even for a medium that decreases in volume, the internal space of the container is always completely filled by the medium. Consequently, the change in volume of the medium is approximately proportional to the displacement of the plunger. In this way the displacement provides a comparatively exact measure of the change in volume of the medium. In turn, the change in volume of the medium can be directly or indirectly linked with the release of the volatile substance. Consequently, with the help of a suitable display device for the displacement, one can read off whether and to what extent the volatile substance has been released.

In a preferred embodiment, the medium is in the form of a carrier that absorbs or stores the volatile substance. As the volatile substance is released, the carrier in the container changes its volume causing the plunger to move and cover a corresponding displacement path. It is also possible that the medium itself is a volatile substance, such as for example, an appropriate solid (for example a waxy solid) that volatilizes over time when released into the surrounding air.

The medium or the carrier may possess luminescent properties. For example, they can be phosphorescent or fluorescent.

As according to the invention the change in volume of the medium/carrier corresponds or should essentially correspond to the change in volume that the internal space experiences from the displacement path of the plunger, the carrier must possess a certain deformability that allows it to conform to the internal space that can be changed by the movable plunger. The carrier preferably possesses a plurality of solid particles that are able to move with respect to their neighboring particles. As they release the volatile substance, these particles shrink and the resulting interstices are filled up due to the movement of the plunger, in that the solid particles are moved towards each other or take up new positions. In comparison with a liquid carrier, the advantage associated with the embodiment with the solid particles consists in that the container need not be sealed to prevent the carrier running out.

The solid particles are preferably made of plastic, in which the volatile material is stored.

In a preferred embodiment, the solid particles are spherical or approximately spherical. However, the particles can also be lenticular, cylindrical or possess other shapes. It is also possible to fill the container with differently shaped particles, such that, for example, spherical and lenticular particles are present in the container. In a particularly preferred embodiment, phosphorescing spheres or pearls are used, which can be formed as fragrant spheres or fragrant pearls.

Fragrant spheres or fragrant pearls are understood to mean in particular particles for deodorizing or freshening rooms, as are described in more detail in DE 10237066.4. These kinds of particles comprise at least one polymeric carrier material as well as at least one fragrance, wherein the polymeric carrier material has a melting point or softening point between 30 and 150° C., preferably between 60 and 100° C. and particularly preferably between 75 and 80° C.

The polymeric carrier material can for example comprise a substance from the group of ethylene/vinyl acetate copolymers, the polyethylenes of low or high density (LOPE, HDPE) or mixtures thereof, polypropylene, a polyethylene/polypropylene copolymer, polyether/polyamide block copolymer, styrene/butadiene (block) copolymer, styrene/isoprene (block) copolymer, styrene/ethylene/butene copolymer, acrylonitrile/butadiene/styrene copolymer, acrylonitrile/butadiene copolymer, polyether ester, polyisobutene, polyisoprene, ethylene/ethyl acrylate copolymer, polyamide, polycarbonate, polyester, polyacrylonitrile, polymethyl methacrylate, polyurethane or a polyvinyl alcohol.

In a preferred embodiment, the particles for deodorization or air freshening comprise at least 10 wt. %, preferably at least 30 wt. % and particularly preferably at least 70 wt. % ethylene/vinyl acetate copolymer, and particularly preferably they are completely produced from ethylene/vinyl acetate copolymer.

In addition it is possible that ethylene/vinyl acetate copolymer be employed as the polymeric carrier material and this copolymer comprises 5 to 50 wt. % vinyl acetate, preferably 10 to 40 wt. % vinyl acetate and particularly 20 to 30 wt. % vinyl acetate, each based on the total weight of the copolymer.

The weight fraction of the fragrance(s) in the particles is 1-70 wt. %, preferably 10-60 wt. % and particularly preferably 20-40 wt. %, in each case based on the total weight of the particles.

In a preferred embodiment, the particles have an average diameter of 0.5 to 20 mm, preferably 1 to 10 mm and especially 3 to 6 mm.

A spring can provide a compressive force with which the plunger is pressed against the medium or against the carrier. The spring can be designed for example as a helical spring or spiral spring. The term “spring” should also include all embodiments in which an elastic component, when deformed, can exercise a force on the plunger.

In a preferred embodiment, the displacement path of the plunger is in a straight line. However, the displacement path could also be curved. For example, the plunger could be rotatable about an axis of rotation, wherein in this case the displacement path would be a circular path.

In a preferred embodiment, the container is designed as a cylinder. Here the displacement path of the plunger can run parallel to a central cylindrical axis of the container. The internal space of the cylinder can be varied by means of an axial movement of the plunger.

The plunger can be designed as a pin that extends into the internal space of the container. The volume of the internal space is consequently reduced by the volume of the section of the pin extending into the internal space.

In a preferred embodiment, the internal space has an essentially constant cross sectional area perpendicular to the displacement path of the plunger, wherein the plunger has a plunger surface that corresponds to the cross sectional area of the container. This, for example, is the case for a cylindrical container, in which the plunger is axially displaceable and the plunger covers the total cross sectional area of the cylindrical container. In this embodiment, the reduction in volume of the carrier, which corresponds to the reduction in volume of the internal space of the container, can be calculated from the product of the displacement path times the plunger surface.

Preferably, at least one graduation and at least one window is provided, through which the graduation is totally or partially visible when a defined quantity of volatile substance has been released. The quantity can be specified such that practically all the volatile substance taken up by the carrier has evaporated. In this way a user of the device recognizes that the device for releasing a volatile substance or, in an appropriately designed embodiment, only the container, needs to be exchanged when the graduation is visible in the window.

A plurality of windows can be provided that are preferably arranged one after the other in the direction of movement of the graduation. For example, three windows can be arranged in a row; when the graduation is behind a first window it shows that a third of the volatile substance is consumed, when the graduation is behind the second window it shows that two thirds of the volatile substance are consumed and when the graduation is behind the third window it shows that the volatile substance is fully consumed.

In a preferred embodiment, the graduation is disposed on the plunger. The plunger therefore glides along past a part of the housing on the window, such that the graduation is visible in the window at a defined plunger position

As an alternative to the embodiment, in which the graduation is applied on the plunger, at least one additional moving component can be provided that carries the graduation and which is preferably mechanically attached to the plunger. This opens several degrees of freedom for the construction of the inventive device, as the plunger does not have to travel directly past the window. Instead of the mechanical linkage a linkage can also be provided that makes the graduation visible in the window. For example, an electrical contact could be closed at a defined displacement path of the plunger, whereby a signal or impulse is produced, by which the graduation is made visible. Instead of the graduation that is visible in the window, another visual element, such as a light emitting diode or an optical element, could also be used.

In a preferred embodiment, a movement of the plunger is converted by a gear into another movement of the movable component. Such a gear, for example, can convert a translational movement of the plunger into a rotational movement of the graduation. With a gear of this type the ratio of the displacement path of the plunger and the distance traveled by the graduation or that of the component carrying the graduation can be adjusted. The ratio does not have to be constant and can, for example, convert a non-linear, time-dependent release characteristic of the volatile substance, which reflects the reduction in volume of the carrier over time, into a movement of the graduation that is linear with respect to time.

The displacement path of the plunger can be maximum 20 mm, preferably 16 mm. In a preferred embodiment, the change in volume of the carrier is maximum 30 vol. %, preferably maximum 20 vol. %.

In a preferred embodiment, the plunger can be locked in at least one position preferably in a starting position by a retainer means. The retainer means prevents the plunger from exerting a force on the medium before the device is brought into use.

The retainer means can include a pin that is connected to the plunger The plunger is activated by separating the connection between the pin and plunger, i.e. the plunger can then travel over a displacement path corresponding to the change in volume of the medium. For example, the pin can be formed integrally with the plunger; by breaking off the pin, the connection is broken and the plunger can move freely.

As stated above, the displacement path of the movable plunger is used as an indicator for the change in volume of the medium and consequently for the amount of the volatile substance released. Accordingly, it is particularly important that the plunger take up a defined starting position when the inventive device has been refilled with the medium or fragrance carrier. This relates particularly to embodiments, in which the carrier includes a plurality of solid particles that have to be filled into the container during manufacture or on refilling the device.

The inventive method for filling a device for releasing a volatile substance, in which solid particles, such as, for example fragrant pearls are used as the carrier for the volatile substance, includes the following process steps. Firstly, a quantity of solid particles is volumetrically metered in a measuring vessel, wherein the measuring vessel is vibrated during metering. The vibrations are intended to provide an as constant as possible fill factor of the solid particles in the measuring vessel, such that the volumetric quantity corresponds to a defined weight. Then the metered quantity of solid particles is filled into the internal space of the container of the device for receiving solid particles, wherein the container is also vibrated during and/or after filling. Also here, the vibrations serve to ensure an identical fill factor of the solid particles so that they take up a pre-determined volume and assume a pre-determined filling height in the container. Finally, the movable plunger is inserted into the device so as to close the container, wherein the inserted plunger presses against the solid particles. As a consequence of the inventive method, the solid particles in the container always have the same filling height, resulting in a pre-defined starting position of the plunger that presses onto the particles.

Preferably, prior to introducing the movable plunger, a compressive force is applied onto the solid particles present in the container. This also serves to attain an as uniform as possible fill factor for the solid particles.

### BRIEF DESCRIPTION OF THE DRAWING FIGURES

The invention is described in more detail with reference to the examples illustrated in the figures. The drawings show:

FIG. 1 is a schematic diagram of a first example;

FIG. 2 is a further example in front elevation;

FIG. 3 is the example of FIG. 2 partially in sectional view from the side;

FIG. 4 is a schematic sectional view of a part of a further example;

FIG. 5 is a plunger from the example of FIG. 4 in perspective view.

### DETAILED DESCRIPTIONS OF THE PREFERRED EMBODIMENTS

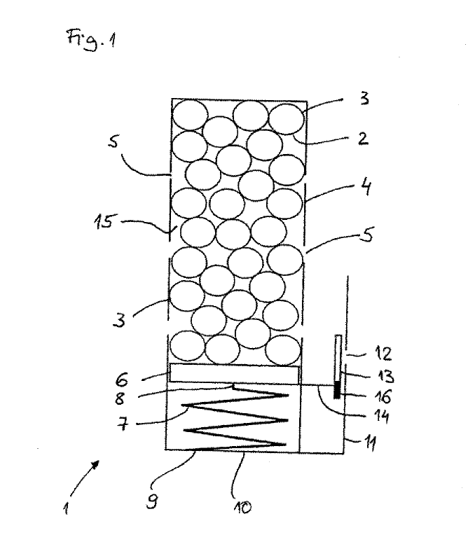

FIG. 1 shows a device for releasing a volatile substance, which in its entirety is referred to with 1. The device 1 includes a carrier 2 that consists of a plurality of plastic spheres 3. The plastic spheres 3 incorporate a volatile substance, for example a fragrance, wherein the plastic spheres 3 shrink when the substance volatilizes out.

The plastic spheres 3 are located in a container 4 that possesses a plurality of openings 5. The volatile substance can egress from the plastic spheres or plastic pearls 3 through the openings 5. The plastic spheres 3 are pressed together in the container 4 by a plunger 6. The compression force with which the plunger 6 presses against the plastic spheres 3 is dimensioned such that said plastic spheres 3 on shrinking are moved towards each other and take up new positions in order that the interstices between the spheres produced by the shrinking are filled up as completely as possible. Assuming a constant packing density of the plastic spheres 3 in the container 4, a displacement path of the plunger 6 in an x-direction is directly proportional to a change in volume of the plastic spheres 3.

A spring 7 presses the plunger 6 against the plastic spheres 3. Consequently, a first end 8 of the spring 7 is braced against the plunger 6 and a second end 9 of the spring 7 is braced against a fixed floor 10 of the device 1.

In addition, the device 1 has an external housing 11 that is only partially illustrated in FIG. 1. In the external housing 11 is provided a window 12, behind which is slideably located a graduated bracket 13. The graduated bracket 13 is fixedly connected to the plunger 6 by a bar 14. The displacement of the plunger 6 corresponds to the displacement of the graduated bracket 13.

As the plastic pearls 3 shrink due to the release of the volatile substance, the spring 7 pushes the plunger 6 upwards, such that an internal space 15 of the container 4 becomes smaller. Consequently, the decrease in volume of the internal space 15 corresponds to the reduction in volume of the plastic spheres 3. As the plunger 6 moves upwards, a colored lower part 16 of the graduated bracket 13 becomes visible through the window 12. The position of plunger 6 and graduated bracket 13 and/or window 12 in the external housing 11 can now be fixed such that the colored lower part 16 of the graduated bracket 13 appears in the window when practically all the volatile substance or fragrance has volatilized out of the plastic pearls 3. This is how it is displayed that the fragrance is used up.

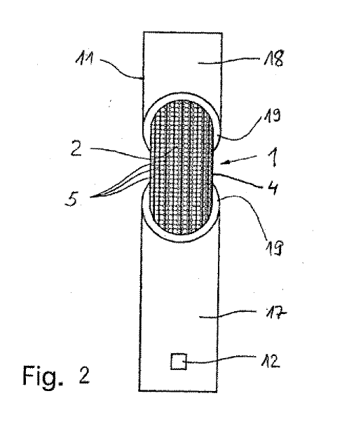

FIG. 2 shows a further example in front elevation. The container 4 is partially covered by the housing 11 that consists of a lower housing half 17 and an upper housing half 18. Container 4 is cylindrical and can be completely closed by turning the upper part of the housing 18 about the cylinder axis. By turning the upper housing half 18 it moves in the axial direction towards the lower housing half 17 until the elliptically shaped sides of the lower and upper housing halves 17, 18 are mutually anchored. The side 19 corresponds to an intersection that results when the external housing 11 is cut diagonally to the cylinder axis of the container 4. One should also take note of the window 12 with a right-angled frame that is designed as an opening or recess in the lower housing half 17.

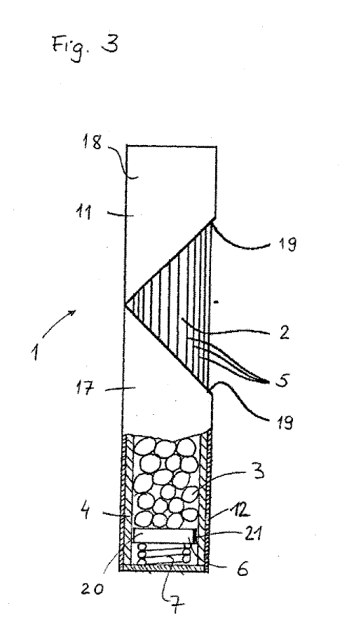

FIG. 3 shows a side view of the device 1, wherein a lower part of device 1 is represented in cross section. The plastic pearls 3 can be seen pressed together in the container 4 by the plunger 6. The peripheral surface 20 of the plunger 6 has a colored marking. As the plastic pearls 3 shrink, the plunger 6 with the colored marking 21 travels past the window 12. As the container 4 is made of a transparent material, the marking 21 is visible behind the window 12.

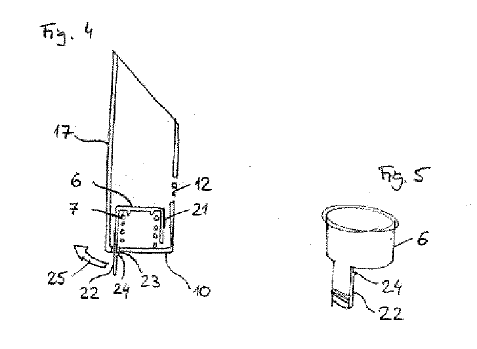

FIGS. 4 and 5 show a schematic sectional view of a part of a further example. The lower housing half 17, in which the plunger 6 is axially movable, is shown in FIG. 4. Between the plunger 6 and the floor 10 is located the spring 7 (here only sketched in) that in the illustration of FIG. 4 presses the plunger 6 upwards. A pin 22 with a square edge is formed integrally with the plunger (see FIG. 5) and pierces through an opening 23 that is provided in the floor 10. The pin 22 has a lug that prevents the pin 22 and hence the plunger 6, from moving upwards. Only when the pin 22 is separated from the plunger 6, by bending it in the direction of the arrow 25, can the plunger 6 be moved corresponding to the change in volume of the plastic spheres 3 (see FIG. 3). With the appropriate displacement path, the marking 21 becomes visible in the window 12 that in the embodiment illustrated here has three partial windows that are arranged one after the other in the axial path of the plunger.

As an alternative to the embodiment illustrated in FIGS. 4 and 5, the pin 22, with a circular cross section, can also stick up from the housing half 17 in the middle of the floor 10. A preferred diameter of the round pin is 2 mm.

List of Reference Numerals

1 Device
2 Medium/carrier
3 Plastic sphere
4 Container
5 Opening
6 Plunger
7 Spring
8 First end
9 Second end
10 Floor
11 External housing
12 Window
13 Graduated bracket
14 Bar
15 Internal space
16 Colored part
17 Lower housing half
18 Upper housing half
19 Side
20 Peripheral surface
21 Marking
22 Pin
23 Opening
24 Lug
25 Arrow

1. Device (1) for releasing a volatile substance, such as a fragrance or the like, with a medium (2) that on releasing the volatile substance undergoes a change in volume, and with a container (4) that has an internal space (15) to receive the medium (2), wherein said internal space (15) of the container (4) is limited by a movable plunger (6) that on a change in volume of the medium travels along a displacement path, wherein the change in volume of the medium (2) essentially corresponds to a change in volume of the internal space (15) that results from the displacement path traveled by the plunger.

2. Device (1) according to claim 1, wherein the medium (2) is in the form of a carrier (2) that absorbs or stores the volatile substance.

3. Device (1) according to claim 2, wherein the carrier (2) comprises a plurality of solid particles (3).

4. Device (1) according to claim 3, wherein the solid particles (3) are made of plastic.

5. Device (1) according to claim 3, wherein the solid particles (3) are substantially spherical.

6. Device (1) according to claim 1, wherein at least one spring (7) furnishes a compressive force, making the plunger (6) press against the medium (2).

7. Device (1) according to claim 1, wherein the displacement path of the plunger (6) is a straight line.

8. Device (1) according to claim 1, wherein the container (4) is cylindrical.

9. Device (1) according to claim 8, wherein the displacement path of the plunger (6) runs parallel to a middle cylindrical axis of the container (4).

10. Device (1) according to claim 1, wherein the plunger (4) is shaped as a pin that extends into the internal space (15) of the container (4).

11. Device (1) according to claim 1, wherein the internal space (15) has an essentially constant cross sectional area perpendicular to the displacement path of the plunger (6) and the plunger (6) has a plunger surface that corresponds to the cross sectional area of the container (4).

12. Device (1) according to claim 1, wherein at least one marking (16, 21) and at least one window (12) are provided, through which the marking flag (16, 21) becomes wholly or partially visible once a certain amount of volatile substance has been released.

13. Device (1) according to claim 12, wherein a plurality of windows (12) are provided that are arranged one behind the other in a direction of movement of the marking (16, 21).

14. Device (1) according to claim 12, wherein the marking (21) is disposed on the plunger (6).

15. Device (1) according to claim 1, wherein at least one additional movable component (14) is provided that carries the marking (16) and is preferably mechanically linked with the plunger (6).

16. Device (1) according to claim 15, wherein a movement of the plunger (6) is converted by a gear into another movement of the movable component (14).

17. Device (1) according to claim 1, wherein the displacement path of the plunger (6) is maximum 20 mm, preferably maximum 16 mm.

18. Device (1) according to claim 1, wherein the change in volume of the medium (2) is maximum 30 vol. %f preferably maximum 20 vol. %.

19. Device (1) according to claim 1, wherein the plunger (6) can be looked in at least one position, preferably in a starting position, by a retainer means (22).

20. Device (1) according to claim 19, wherein the retainer means comprises a pin (22) that is linked with the plunger (6), wherein the plunger (6) is activated when this link is detached.

21. Method for filling a device for releasing a volatile substance according to claim 3, wherein the method includes the following process steps:
a quantity of solid particles is volumetrically metered into a measuring vessel, said solid particles taking up or incorporating the volatile substance, wherein the measuring vessel is vibrated during metering;
the metered quantity of solid particles is filled into the internal space of a container of the device for receiving the solid particles, wherein the container is also vibrated during and/or after filling; and
a movable plunger is inserted into the device so as to close the container, wherein the inserted plunger presses against the solid particles.

22. Method according to claim 21, wherein prior to inserting the movable plunger, a compressive force is applied on the solid particles present in the container.
